(19) United States
(12) Patent Application Publication
(10) Pub. No.: US 2005/0137924 A1
(43) Pub. Date: Jun. 23, 2005

(54) Method and System for a resource allocation and analysis decision support tool

(76) Inventors: Vish Aiyah, Folsom, CA (US); Debra L. Osfeld, Sacramento, CA (US); Dana L. Roe, Shingle Springs, CA (US); Bruce A. Smith, Carmichael, CA (US); Peter Bady, Orangevale, CA (US); Shaobin Liu, Orangevale, CA (US); Eric E. Collins, Los Cruces, CA (US); Jefferson A. Thomas, Mather, CA (US); Victoria A. Haynes, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,996

(22) Filed: Dec. 23, 2003

(51) Int. Cl. G06F 17/60

(52) U.S. Cl. 705/8

(57) ABSTRACT

A method and system for a resource allocation and analysis decision support tool is described. The method includes creating fields for entering data related to projects and resources, generating a list of multiple projects based on the data entered in the fields, and generating for viewing and editing a list showing which projects each resource is assigned to.

### BACKGROUND

1. Technical Field

Embodiments of the invention relate to the field of project resource tools, and more specifically to a resource allocation and analysis decision support tool.

2. Background Information and Description of Related Art

Managers as well as individuals in a company desire to optimize the utilization of resources to support various projects and activities. However, the information about resource availability across multiple groups or allocation across multiple projects is often not available. Current tools only offer storage of indicators for a specific project. Information and reports about resource availability and resource allocation across multiple projects is not available in these tools.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is an exemplary project information report according to an embodiment of the invention.

FIG. 3 is an exemplary resource allocation summary according to an embodiment of the invention.

FIG. 4 is an exemplary vacation information report according to an embodiment of the invention.

FIG. 5 is an exemplary milestone information report according to an embodiment of the invention.

FIG. 6 is a flow diagram illustrating a method according to an embodiment of the invention.

FIG. 7 is a block diagram illustrating a suitable computing environment in which certain aspects of the illustrated invention may be practiced.

### DETAILED DESCRIPTION

Embodiments of a system and method for a resource allocation and analysis decision support tool are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

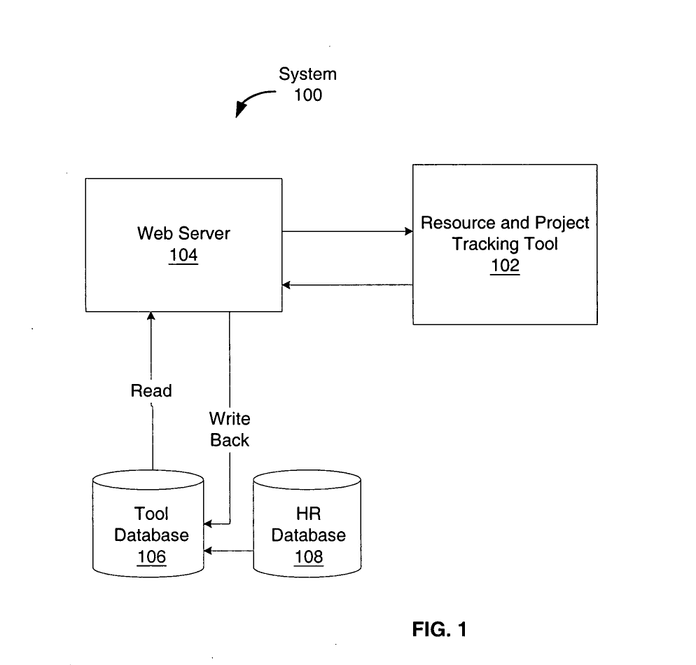

Referring to FIG. 1, a block diagram illustrates a system 100 according to one embodiment of the invention. Those of ordinary skill in the art will appreciate that the system 100 may include more components than those shown in FIG. 1. However, it is not necessary that all of these generally conventional components be shown in order to disclose an illustrative embodiment for practicing the invention.

System 100 includes a resource allocation and analysis decision support tool 102. The tool 102 allows management as well as individuals to make informed decisions by optimally utilizing resources to support activities and projects. The tool 102 allows individuals to enter and edit resource and project information, view summaries of resources within multiple organizational levels and projects, view resource availability and vacation time, view project summaries, and generate various other reports. The tool 102 is connected to a web server 104 to allow individuals to enter, edit, and view information over the web. Resource and project information may be stored in a tool database 106. Information from a human resources (HR) database 108 may be written to the tool database 106 as the information changes. This provides a central repository for resource and project information.

Various reports, graphs, and summaries may be generated by the tool 102 according to the user's needs. These reports may include a list of all projects and whether they are in progress, a list of resources and their availability, a list of resources and their scheduled time off, a list of resources and what projects they are assigned to, a summary of project allocation across organizations, a list of all new projects, a list of project milestones, and a list of project and resource head count. Projects may also be sorted using various criteria, such as size, risk, or priority.

Security may be maintained by maintaining a global user list. The user list identifies which level of security the user is entitled to and what role best describes the user. For example, any individual may edit his own resource information, but a manager role may be necessary to edit project information, or a system administrator role may be necessary to edit fields and picklists.

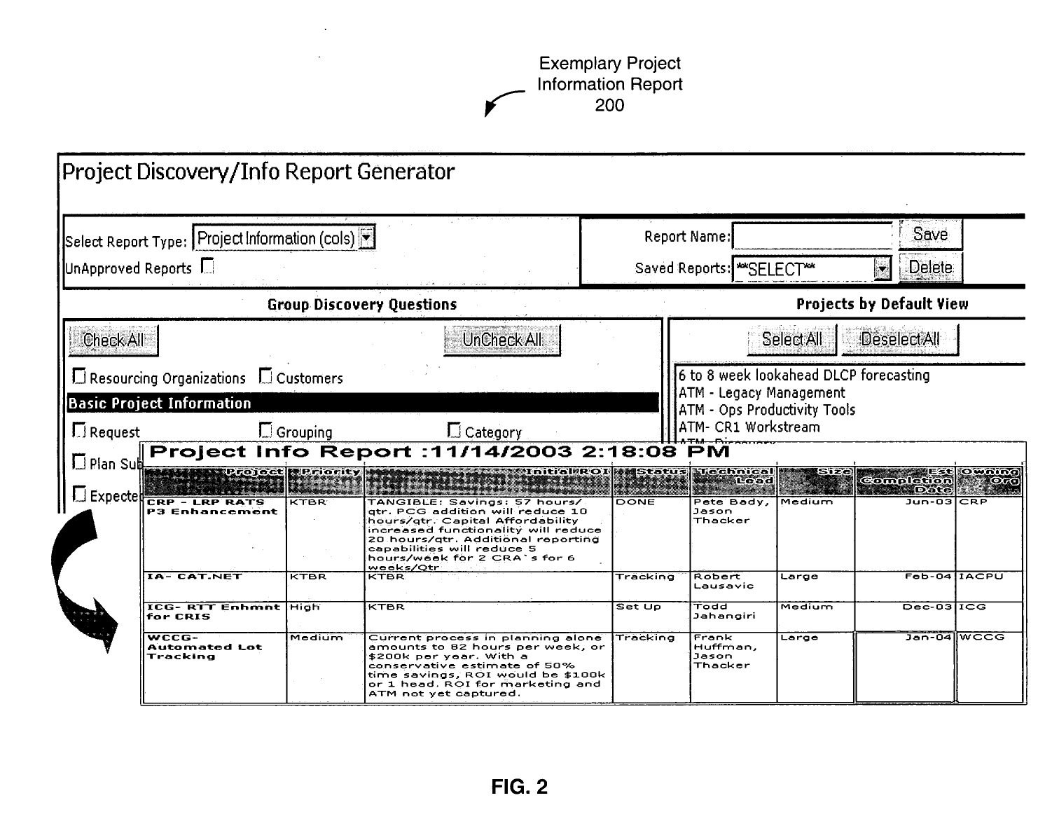

FIG. 2 is an exemplary project information report according to an embodiment of the invention. A system administrator may set up different fields for entering information about resources and projects. Picklists for particular fields may also be set up to allow a user to pick from several options. Individuals may then enter data about themselves. Project data may also be entered. Once the data about resources and projects is collected, the tool 102 may generate different summaries and reports for viewing. For example, FIG. 2 illustrates an exemplary project information report generated by tool 102. The project information report shown includes various information about different projects currently in progress.

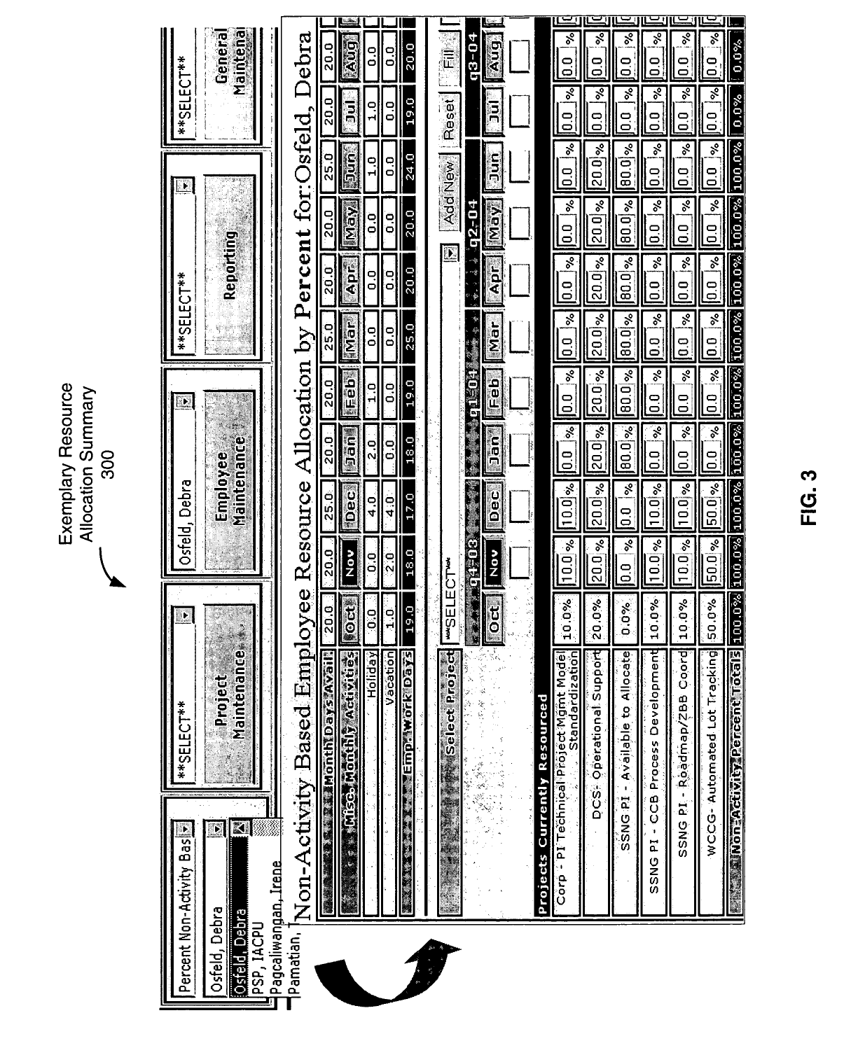

FIG. 3 is an exemplary resource allocation summary according to an embodiment of the invention. This summary shows resource allocation information about a specific resource, including the resource's availability and the resource's allocation across multiple projects.

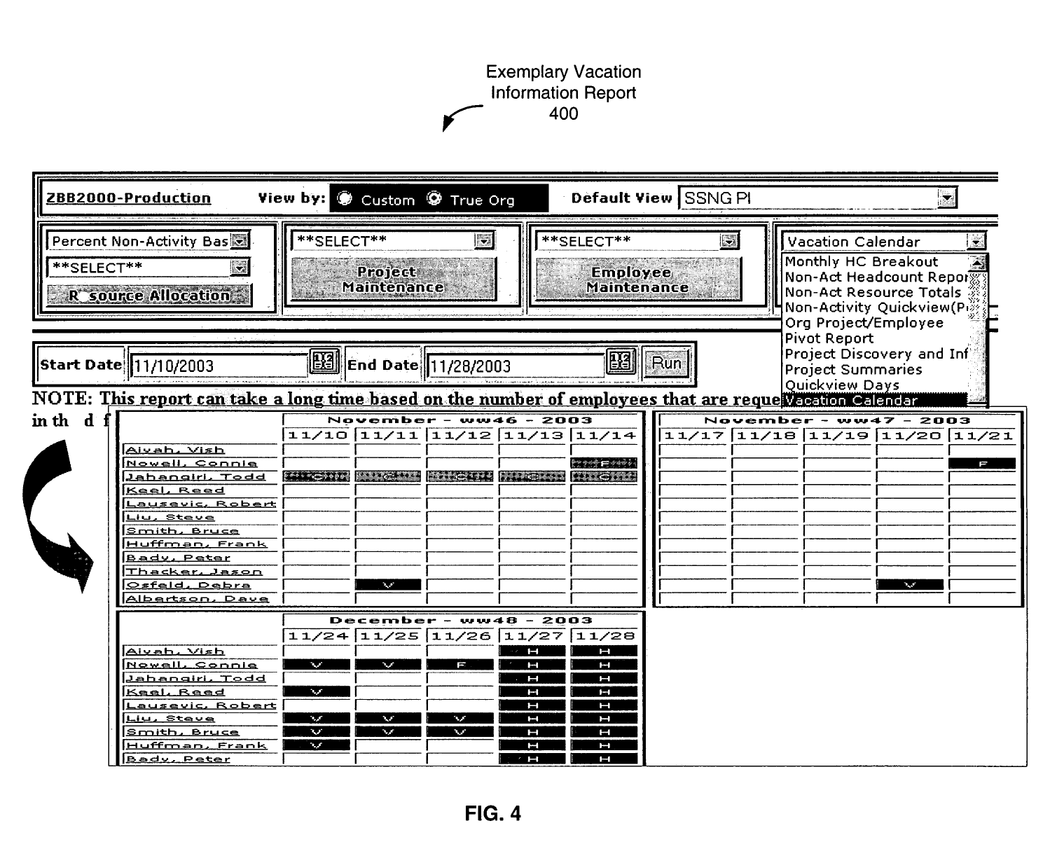

FIG. 4 is an exemplary vacation information report according to an embodiment of the invention. This report shows the vacation time of multiple resources for a selected time period.

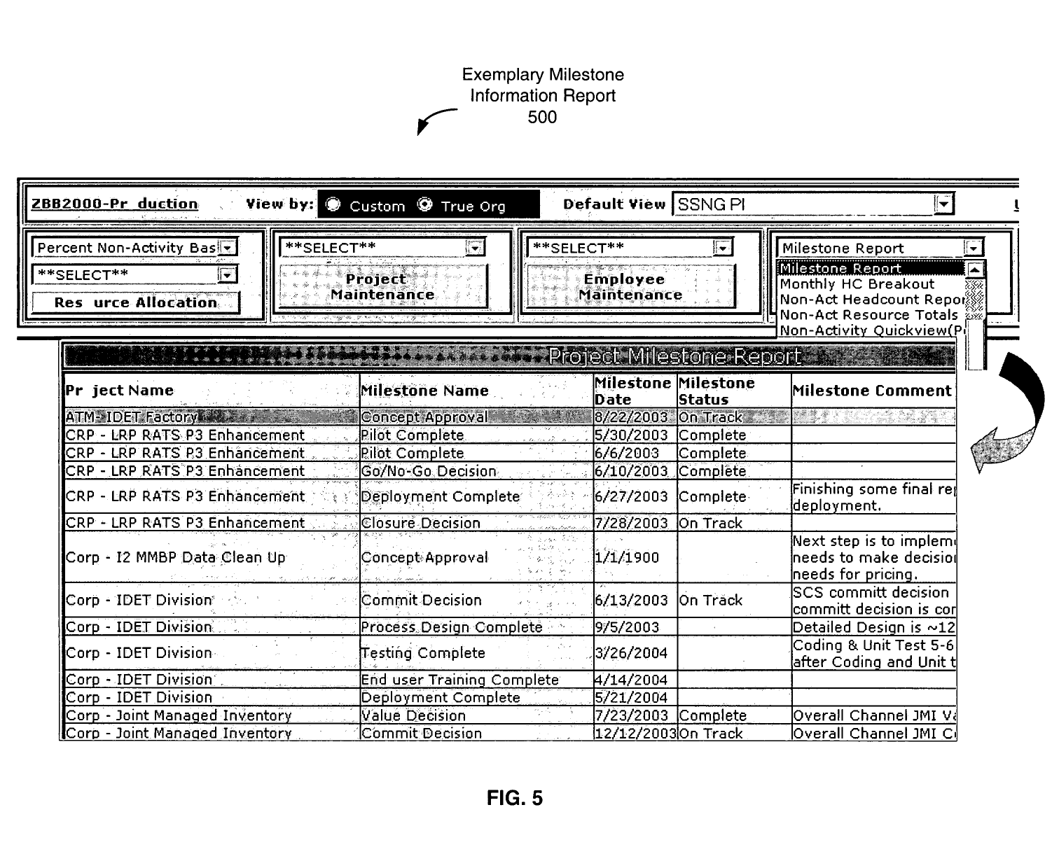

FIG. 5 is an exemplary milestone information report according to an embodiment of the invention. This report shows milestone dates and status for projects currently in progress. Various other reports and summaries may be generated to meet the user's needs.

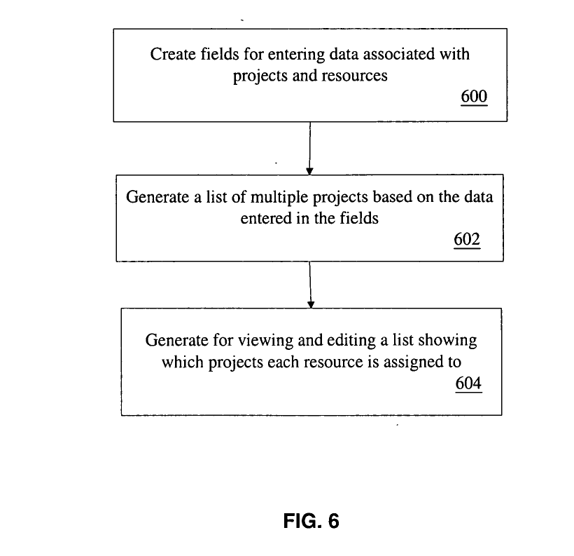

FIG. 6 illustrates a method according to one embodiment of the invention. At 600, fields for entering data related to projects and resources are created. At 602, a list of multiple projects based on the data entered in the fields is generated. In one embodiment, a list of projects currently in progress is generated. In one embodiment, a list of new projects that have been started within a selected time frame is generated. In one embodiment, the multiple projects are sorted based on a predetermined criteria, such as priority, size, or risk. At 604, a viewable and editable list showing which projects each resource is assigned to is generated. In one embodiment, a resource list showing the availability of each resource is generated. The resource list may show the vacation time of each resource. In one embodiment, a milestone list indicating the milestone dates of each of the multiple projects is generated.

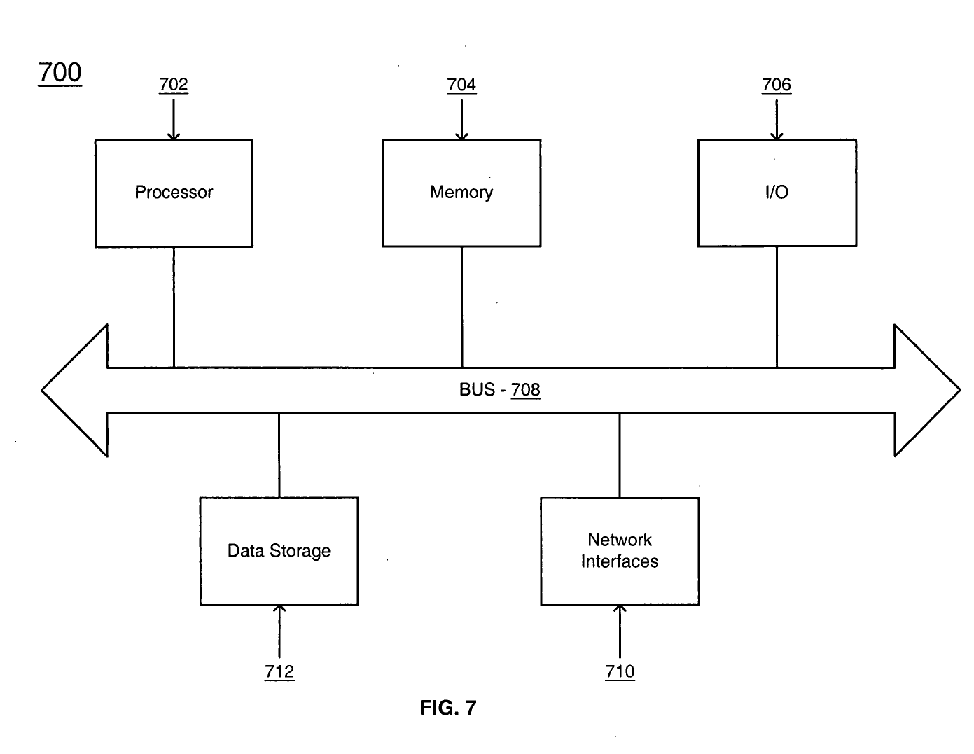

FIG. 7 is a block diagram illustrating a suitable computing environment in which certain aspects of the illustrated invention may be practiced. In one embodiment, the method described above may be implemented on a computer system 700 having components 702-712, including a processor 702, a memory 704, an Input/Output device 706, a data storage device 712, and a network interface 710, coupled to each other via a bus 708. The components perform their conventional functions known in the art and provide the means for implementing the system 100. Collectively, these components represent a broad category of hardware systems, including but not limited to general purpose computer systems and specialized packet forwarding devices. It is to be appreciated that various components of computer system 700 may be rearranged, and that certain implementations of the present invention may not require nor include all of the above components. Furthermore, additional components may be included in system 700, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
creating fields for entering data associated with projects and resources;
generating a list of multiple projects based on the data entered in the fields; and
generating for viewing and editing a list showing which projects each resource is assigned to.

2. The method of claim 1, further comprising generating a resource list showing the availability of each resource.

3. The method of claim 2, wherein generating a resource list showing the availability of each resource comprises generating a resource list showing the vacation time of each resource.

4. The method of claim 1, further comprising generating a milestone list indicating the milestone dates of each of the multiple projects.

5. The method of claim 1, wherein creating fields for entering data associated with projects and resources comprises creating fields for entering data associated with projects and resources on a web based tool.

6. The method of claim 1, wherein generating a list of multiple projects comprises generating a list of multiple projects currently in progress.

7. The method of claim 1, wherein generating a list of multiple projects comprises generating a list of multiple projects that have been started within a selected time frame.

8. The method of claim 1, further comprising sorting the multiple projects based on a predetermined criteria.

9. The method of claim 8, wherein sorting the multiple projects based on a predetermined criteria comprises sorting the multiple projects based on a priority of each project.

10. The method of claim 8, wherein sorting the multiple projects based on a predetermined criteria comprises sorting the multiple projects based on a size of each project.

11. An article of manufacture comprising:
a machine accessible medium including content that when accessed by a machine causes the machine to perform operations comprising:
creating fields for entering data associated with projects and resources;
generating a list of multiple projects based on the data entered in the fields; and
generating for viewing and editing a list showing which projects each resource is assigned to.

12. The article of manufacture of claim 11, wherein the machine-accessible medium further includes content that causes the machine to perform operations comprising generating a resource list showing the availability of each resource.

13. The article of manufacture of claim 12, wherein the machine accessible medium including content that when accessed by the machine causes the machine to perform operations comprising generating a resource list showing the availability of each resource comprises the machine accessible medium including content that when accessed by the machine causes the machine to perform operations comprising generating a resource list showing the vacation time of each resource.

14. The article of manufacture of claim 11, wherein the machine-accessible medium further includes content that causes the machine to perform operations comprising generating a milestone list indicating the milestone dates of each of the multiple projects.

15. The article of manufacture of claim 11, wherein the machine accessible medium including content that when accessed by the machine causes the machine to perform operations comprising creating fields for entering data associated with projects and resources comprises the machine accessible medium including content that when accessed by the machine causes the machine to perform operations comprising creating fields for entering data associated with projects and resources on a web based tool.

16. The article of manufacture of claim 11, wherein the machine accessible medium including content that when accessed by the machine causes the machine to perform operations comprising generating a list of multiple projects comprises the machine accessible medium including content that when accessed by the machine causes the machine to perform operations comprising generating a list of multiple projects currently in progress.

17. The article of manufacture of claim 11, wherein the machine accessible medium including content that when accessed by the machine causes the machine to perform operations comprising generating a list of multiple projects comprises the machine accessible medium including content that when accessed by the machine causes the machine to perform operations comprising generating a list of multiple projects that have been started within a selected time frame.

18. The article of manufacture of claim 11, wherein the machine-accessible medium further includes content that causes the machine to perform operations comprising sorting the multiple projects based on a predetermined criteria.

19. The article of manufacture of claim 18, wherein the machine accessible medium including content that when accessed by the machine causes the machine to perform operations comprising sorting the multiple projects based on a predetermined criteria comprises the machine accessible medium including content that when accessed by the machine causes the machine to perform operations comprising sorting the multiple projects based on a priority of each project.

20. The article of manufacture of claim 18, wherein the machine accessible medium including content that when accessed by the machine causes the machine to perform operations comprising sorting the multiple projects based on a predetermined criteria comprises the machine accessible medium including content that when accessed by the machine causes the machine to perform operations comprising sorting the multiple projects based on a size of each project.

21. A system comprising:
a processor;
a network interface coupled to the processor; and
a machine accessible medium including data that when accessed by the processor causes the processor to perform operations comprising:
creating fields for entering data associated with projects and resources;
generating a list of multiple projects based on the data entered in the fields; and
generating for viewing and editing a list showing which projects each resource is assigned to.

22. The system of claim 21, wherein the machine-accessible medium further includes content that causes the machine to perform operations comprising generating a resource list showing the availability of each resource.

23. The system of claim 21, wherein the machine-accessible medium further includes content that causes the machine to perform operations comprising generating a milestone list indicating the milestone dates of each of the multiple projects.
